(19) United States
(12) Patent Application Publication
(10) Pub. No.: US 2019/0372620 A1
(43) Pub. Date: Dec. 5, 2019

(54) LOSSLESS COUPLING STRUCTURE OF POWER LINE COMMUNICATION SIGNALS BETWEEN DIFFERENT PHASE LINES

(71) Applicant: Lite Puter Enterprise Co., Ltd., New Taipei City (TW)

(72) Inventor: KUN-PAI HSU, TAIPEI CITY (TW)

(21) Appl. No.: 16/430,452

(22) Filed: Jun. 4, 2019

(30) Foreign Application Priority Data
Jun. 4, 2018 (CN) 201820854948.7

(51) Int. Cl. H04B 3/56; H04B 3/54

(52) U.S. Cl. CPC H04B 3/56; H02J 3/20; H04B 3/542

(57) ABSTRACT

A lossless coupling structure of power line communication signals between different phase lines includes two signal coupling and isolation modules, two signal receiving and transmitting modules, and a digital signal processing module. The signal coupling and isolation modules load a control signal into a power line or extract from the power line, and isolate alternating current. The signal receiving and transmitting modules digitalize an analog signal extracted from the power line by the signal coupling and isolation modules to be loaded into the power line. The digital signal processing module digitally processes and exchanges signals obtained from power lines for A and B phases.

### CROSS-REFERENCE TO RELATED PATENT APPLICATION

This application claims the benefit of priority to China Patent Application No. 201820854948.7, filed on Jun. 4, 2018 in the People's Republic of China. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to power line communication, and more particularly to a lossless coupling structure of power line communication signals between different phase lines.

### BACKGROUND OF THE DISCLOSURE

In power line communication, signal coupling between different phase lines has different degrees of attenuation, and the transmission distance of signals will be affected accordingly. That is, signal coupling attenuation between phases is one of the disadvantages of power line communication.

### SUMMARY OF THE DISCLOSURE

In response to the above-referenced technical inadequacies, the present disclosure provides a lossless coupling structure of power line communication signals between different phase lines.

The lossless coupling structure of power line communication signals between different phase lines includes two signal coupling and isolation modules, two signal receiving and transmitting modules and a digital signal processing module. The signal coupling and isolation modules are used to load a control signal into a power line or extract the control signal from the power line, and isolate alternating current. The signal receiving and transmitting modules are used to digitalize an analog signal extracted from the power line by the signal coupling and isolation modules, or convert a digital signal to an analog signal to be loaded into the power line by the signal coupling and isolation modules. The digital signal processing module digitally processes and exchanges signals obtained from power lines for A and B phases.

The advantage of the lossless coupling structure is that signals of different phase lines are isolated and classified into different signal receiving and transmitting modules, thereby avoiding mutual interference of signals between different phase lines, reducing signal attenuation and ensuring signal transmission distances.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a schematic view of a lossless coupling structure according to the present disclosure.

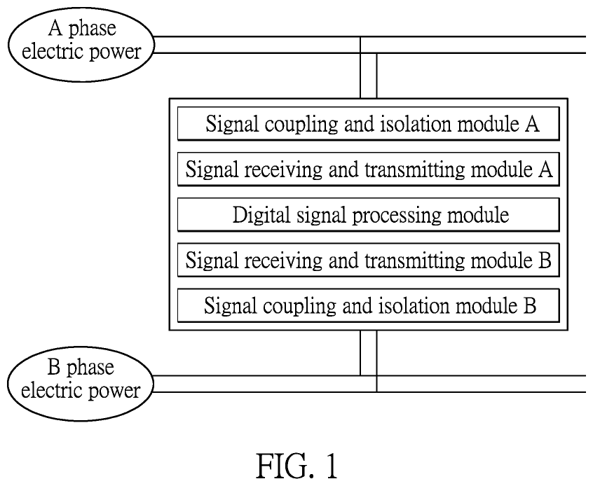

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

A lossless coupling structure of power line communication signals between different phase lines includes two signal coupling and isolation modules (A, B), two signal receiving and transmitting modules (A, B) and a digital signal processing module. The signal coupling and isolation modules A and B are used to load a control signal into a power line or extract the control signal from the power line, and isolate alternating current; the signal receiving and transmitting modules A and B are used to digitalize an analog signal extracted from the power line by the signal coupling and isolation modules A and B, or convert a digital signal to an analog signal to be loaded into the power line by the signal coupling and isolation modules A and B; the digital signal processing module digitally processes and exchanges signals obtained from power lines for A and B phases.

For example, in the workflow of the lossless coupling structure, the steps of a carrier signal of an A-phase power line coupled to a B-phase power line are as follows:
1. extracting a control signal from the A-phase power line by the signal coupling and isolation module A when the carrier signal of the A-phase is passing through the signal coupling and isolation module A;
2. digitalizing an analog signal by the signal receiving and transmitting module A, wherein the analog signal is extracted from the A-phase power line by the signal coupling and isolation module A;
3. digitally processing the signals obtained from the A-phase power line by the digital signal processing module and transmitting to the signal receiving and transmitting module B;
4. converting the digital signal to the analog signal by the signal receiving and transmitting module B to be loaded into the B-phase power line by the signal coupling and isolation module B;
   and the steps of a carrier signal of the B-phase power line coupled to the A-phase power line are conducted similarly.

The advantage of the lossless coupling structure is that signals of different phase lines are isolated and classified into different signal receiving and transmitting modules, thereby avoiding mutual interference of signals of different phase lines, reducing signal attenuation and ensuring signal transmission distances. The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A lossless coupling structure of power line communication signals between different phase lines comprising: two signal coupling and isolation modules, two signal receiving and transmitting modules and a digital signal processing module,
wherein, the signal coupling and isolation modules are used to load a control signal into a power line or extract the control signal from the power line, and isolate alternating current; the signal receiving and transmitting modules are used to digitalize an analog signal extracted from the power line by the signal coupling and isolation modules, or convert a digital signal to an analog signal to be loaded into the power line by the signal coupling and isolation modules; the digital signal processing module digitally processes and exchanges signals obtained from power lines for A and B phases.
